(19) United States
(12) Patent Application Publication
(10) Pub. No.: US 2014/0077603 A1
(43) Pub. Date: Mar. 20, 2014

(54) POWER SUPPLY APPARATUS WITH POWER BACKUP MECHANISM

(71) Applicant: FSP TECHNOLOGY INC., Taoyuan County (TW)

(72) Inventors: Tung-Jung Chuang, Taoyuan County (TW); Shung-Hung Wu, Taoyuan County (TW)

(73) Assignee: FSP TECHNOLOGY INC., Taoyuan County (TW)

(21) Appl. No.: 14/028,553

(22) Filed: Sep. 17, 2013

(30) Foreign Application Priority Data
Sep. 17, 2012 (TW) 101134019

(51) Int. Cl. H02J 9/06

(52) U.S. Cl. CPC H02J 9/061
USPC 307/64

(57) ABSTRACT

A power supply apparatus is provided. The provided power supply apparatus has a power backup mechanism, in which a main DC power and a backup DC power are switched by a fast switching circuit composed of a plurality of switch transistors. Since the switching time of each switch transistor is substantially shorter than that of the conventional relay, the backup DC power can be conducted to the input of the multi-output DC-DC converter at a quite-short time even though the main DC power is abnormal. Accordingly, the output of the multi-output DC-DC converter still can continuously and stably supply the operation power required by the load.

### CROSS-REFERENCE TO RELATED APPLICATION

This application claims the priority benefit of Taiwan application serial no. 101134019, filed on Sep. 17, 2012. The entirety of the above-mentioned patent application is hereby incorporated by reference herein and made a part of this specification.

### BACKGROUND

1. Technical Field

The invention relates to a power supply technique. Particularly, the invention relates to a power supply apparatus with a power backup mechanism.

2. Related Art

A conventional power supply apparatus with a power backup mechanism may simultaneously generate a main DC power and a backup DC power during operation, and a relay is used to receive one of the main DC power and the backup DC power and transmits the same to a post-end DC-DC converter for conversion. In this way, the DC-DC converter may generate a plurality of operation DC voltages to an applied load (for example, a computer system, a communication system, etc.).

Generally, when the main DC power is normally supplied, the relay transmits the received main DC power to the post-end DC-DC converter. However, when the main DC power is abnormal (for example, disappeared or disabled), the relay switches to transmit the received backup DC power to the post-end DC-DC converter. In this way, even if the main DC power is abnormal, the power supply apparatus can still maintain the existing power supply effect.

However, regarding the power supply apparatus with the power backup mechanism that is applied to a communication system, the main DC power, the backup DC power and all of the operation DC voltages have a negative level. Therefore, when the main DC power is abnormal (for example, disappeared or disabled), since a switching time of the relay is excessively long (which is generally greater than 50 ms), the DC-DC converter transitorily stops outputting (due to that the voltage of the negative level can quickly raise to a ground potential) until the relay transmits the backup DC power to the DC-DC converter after 50 ms.

Therefore, the output of the DC-DC converter is transitorily stopped and recovered when the main DC power is abnormal (for example, disappeared or disabled), which not only leads to unstableness of the applied communication system, but may also lead to failure of the applied communication system.

### SUMMARY

Accordingly, the invention is directed to a power supply apparatus with a power backup mechanism, which is capable of effectively resolving the problems mentioned in the related art.

An exemplary embodiment of the invention provides a power supply apparatus including a main direct current (DC) power generating unit, a backup DC power generating unit, a power conversion unit and a fast switching circuit. The main DC power generating unit is configured to generate a main DC power. The backup DC power generating unit is configured to generate a backup DC power. The power conversion unit is configured to generate an operation power required by a load in response to one of the main DC power and the backup DC power.

The fast switching circuit is coupled to the main DC power generating unit, the backup DC power generating unit and the power conversion unit, and includes a plurality of switch transistors. The fast switching circuit is configured to receive the main DC power and the backup DC power, and conducts the backup DC power to the power conversion unit through a first portion of the switch transistors in response to a first control signal and a second control signal when the main DC power is abnormal, otherwise, conducts the main DC power to the power conversion unit through a second portion of the switch transistors in response to the first control signal and the second control signal when the main DC power is normally supplied.

In an exemplary embodiment of the invention, the first portion of the switch transistors includes a first switch transistor and a second switch transistor. A drain of the first switch transistor receives the backup DC power, and a gate of the first switch transistor receives the first control signal. A source of the second switch transistor is coupled to a source of the first switch transistor, a drain of the second switch transistor is coupled to an input of the power conversion unit, and a gate of the second switch transistor receives the first control signal.

In an exemplary embodiment of the invention, the second portion of the switch transistors includes a third switch transistor, where a source thereof receives the main DC power, a drain thereof is coupled to the input of the power conversion unit, and a gate thereof receives the second control signal.

In an exemplary embodiment of the invention, the power supply apparatus further includes a control unit, which is coupled to the main DC power generating unit and the fast switching circuit, and is configured to receive and detect whether the main DC power is abnormal, and accordingly generate the first control signal and the second control signal to switch the switch transistors, where the first control signal and the second control signal are inversed to each other.

In an exemplary embodiment of the invention, the first and second switch transistors are turned on in response to the first control signal when the main DC power is abnormal, and are turned off when the main DC power is normally supplied. Moreover, the third switch transistor is turned on in response to the second control signal when the main DC power is normally supplied, and is turned off when the main DC power is abnormal.

In an exemplary embodiment of the invention, the power conversion unit includes a multi-output DC-DC converter, and the operation power includes a plurality of operation DC voltages.

Another exemplary embodiment of the invention provides a power supply apparatus including a power conversion unit and a fast switching circuit. The power conversion unit generates an operation power required by a load in response to one of a main DC power and a backup DC power. The fast switching circuit is coupled to the power conversion unit, and includes a plurality of switch transistors. The fast switching circuit is configured to receive the main DC power and the backup DC power, and conducts the backup DC power to the power conversion unit through a first portion of the switch transistors in response to a first control signal and a second control signal when the main DC power is abnormal, otherwise, conducts the main DC power to the power conversion unit through a second portion of the switch transistors in response to the first control signal and the second control signal when the main DC power is normally supplied.

According to the above descriptions, the power supply apparatus of the invention has a power backup mechanism, in which a main DC power and a backup DC power are switched by a fast switching circuit composed of a plurality of switch transistors (i.e. the main DC power or the backup DC power is conducted to the post-end multi-output DC-DC converter). Since a switching time (which is smaller than 4 ms) of each switch transistor is substantially shorter than a switching time (which is greater than 50 ms) of the conventional relay, the backup DC power can be conducted to the input of the multi-output DC-DC converter in a quite-short time even though the main DC power is abnormal (for example, disappeared or disabled). Accordingly, the output of the multi-output DC-DC converter can still continuously and stably supply the operation power required by the load. In this way, the problems mentioned in the related art are effectively mitigated/resolved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a power supply apparatus 10 with a power backup mechanism according to an exemplary embodiment of the invention.

FIG. 2 is an implementation of a fast switching circuit 107 of FIG. 1.

### DETAILED DESCRIPTION OF DISCLOSED EMBODIMENTS

Reference will now be made in detail to the present embodiments of the invention, examples of which are illustrated in the accompanying drawings. Wherever possible, the same reference numbers are used in the drawings and the description to refer to the same or like parts.

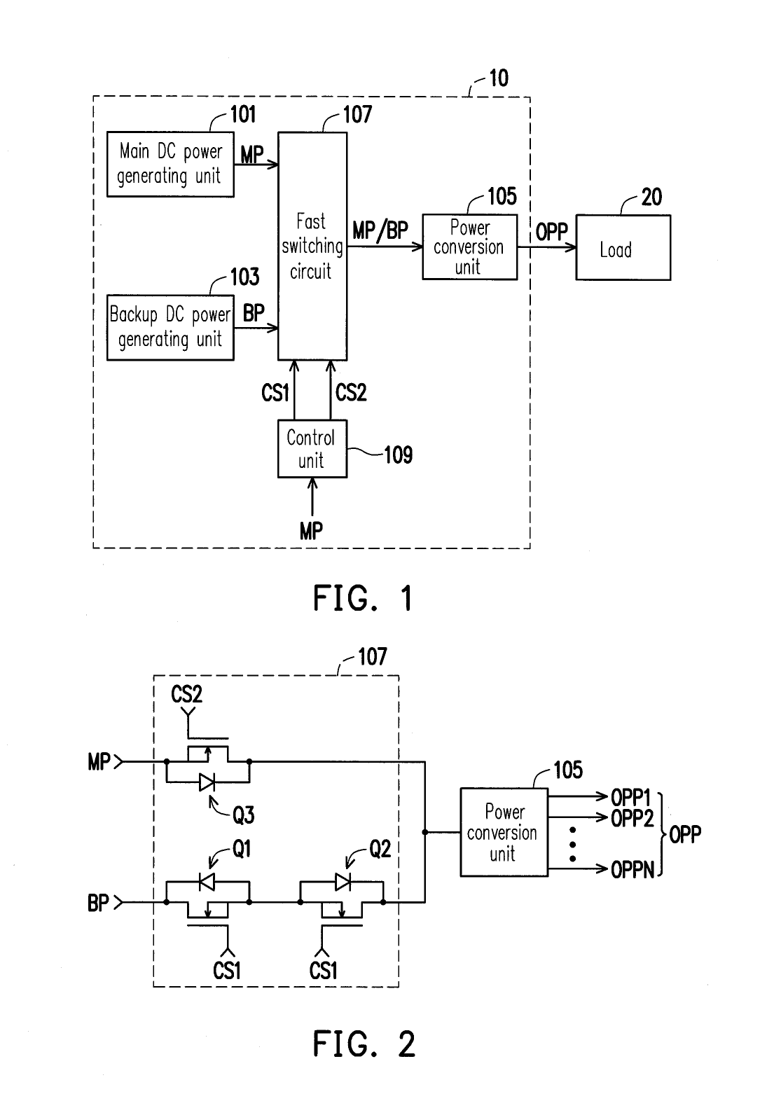

FIG. 1 is a block diagram of a power supply apparatus 10 with a power backup mechanism according to an exemplary embodiment of the invention, and FIG. 2 is an implementation of a fast switching circuit 107 of FIG. 1. Referring to FIG. 1 and FIG. 2, the power supply apparatus 10 is configured to generate an operation power OPP required by a load 20, and includes a main DC power generating unit 101, a backup DC power generating unit 103, a power conversion unit 105, a fast switching circuit 107 and a control unit 109.

In the exemplary embodiment, the main DC power generating unit 101 is configured to generate a main DC power MP. The backup DC power generating unit 103 is configured to generate a backup DC power BP. The power conversion unit 105 is configured to generate the operation power OPP required by the load 20 in response to the main DC power MP or the backup DC power BP conducted and output by the fast switching circuit 107. It should be noticed that the power conversion unit 105 can be implemented by a multi-output DC-DC converter, though the invention is not limited thereto. In this case, the operation power OPP generated by the power conversion unit 105 may include a plurality of operation DC voltages OPPi (i=1-N), and N can be determined according to an actual application requirement.

The fast switching circuit 107 is coupled to the main DC power generating unit 101, the backup DC power generating unit 103 and the power conversion unit 105, and may include a plurality of switch transistors Q1-Q3. In the present exemplary embodiment, the fast switching circuit 107 is configured to receive the main DC power MP generated by the main DC power generating unit 101 and the backup DC power BP generated by the backup DC power generating unit 103.

Moreover, when the main DC power MP received by the fast switching circuit 107 is abnormal (for example, disappeared or disabled, though the invention is not limited thereto), the fast switching circuit 107 conducts the received backup DC power BP to the power conversion unit 105 through a first portion (for example, the switch transistors Q1 and Q2) of the switch transistors Q1-Q3 in response to control signals CS1 and CS2 generated by the control unit 109. Moreover, when the main DC power MP received by the fast switching circuit 107 is normally supplied, the fast switching circuit 107 conducts the received main DC power MP to the power conversion unit 105 through a second portion (for example, the switch transistor Q3) of the switch transistors Q1-Q3 in response to the control signals CS1 and CS2 generated by the control unit 109.

In detail, a drain of the switch transistor Q1 receives the backup DC power BP generated by the backup DC power generating unit 103, and a gate of the switch transistor Q1 receives the control signal CS1 generated by the control unit 109. A source of the switch transistor Q2 is coupled to a source of the switch transistor Q1, a drain of the switch transistor Q2 is coupled to an input (terminal) of the power conversion unit 105, and a gate of the switch transistor Q2 receives the control signal CS1 generated by the control unit 109. A source of the switch transistor Q3 receives the main DC power MP generated by the main DC power generating unit 101, a drain of the switch transistor Q3 is coupled to the input (terminal) of the power conversion unit 105, and a gate of the switch transistor Q3 receives the control signal CS2 generated by the control unit 109.

In the present exemplary embodiment, all of the switch transistors Q1-Q3 can be implemented by power switches, though the invention is not limited thereto, and other types of switch device(s) can also be applied, for example, a bipolar junction transistors (BJTs), metal-oxide-semiconductor field emission transistor (MOSFETs), etc.

On the other hand, the control unit 109 is coupled to the main DC power generating unit 101 and the fast switching circuit 107, and is configured to receive and detect whether the main DC power MP generated by the main DC power generating unit 101 is abnormal, and accordingly generates the control signals CS1 and CS2 inversed to each other to switch the switch transistors Q1-Q3 in the fast switching circuit 107. For example, when the control unit 109 detects that the main DC power MP generated by the main DC power generating unit 101 is lower than (when the output of the power conversion unit 105 has a positive level) or higher than (when the output of the power conversion unit 105 has a negative level) a predetermined value, the control unit 109 determines that the main DC power MP generated by the main DC power generating unit 101 is abnormal. However, the detection method of the control unit 109 on the main DC power MP is not limited thereto, which can be determined according to an actual design requirement.

In an exemplary embodiment, the switch transistors Q1 and Q2 are turned on in response to the control signal CS1 generated by the control unit 109 when the main DC power MP generated by the main DC power generating unit 101 is abnormal, and are turned off when the main DC power MP generated by the main DC power generating unit 101 is normally supplied. Moreover, the switch transistor Q3 is turned on in response to the control signal CS2 generated by the control unit 109 when the main DC power MP generated by the main DC power generating unit 101 is normally supplied, and is turned off when the main DC power MP generated by the main DC power generating unit 101 is abnormal. In other words, when the switch transistors Q1 and Q2 are turned on, the switch transistor Q3 is turned off; and when the switch transistors Q1 and Q2 are turned off, the switch transistor Q3 is turned on.

According to the above descriptions, when the power supply apparatus 10 normally operates, the main DC power MP generated by the main DC power generating unit 101 and the backup DC power BP generated by the backup DC power generating unit 103 are simultaneously generated. Moreover, the control unit 109 receives and detects whether the main DC power MP generated by the main DC power generating unit 101 is abnormal.

It is assumed that the main DC power MP generated by the main DC power generating unit 101 is abnormal (for example, disappeared or disabled, though the invention is not limited thereto), the control unit 109 generates the control signals CS 1 and CS2 to simultaneously turn on the switch transistors Q1 and Q2 and turn off the switch transistor Q3. In this way, the fast switching circuit 107 conducts the received backup DC power BP to the power conversion unit (multi-output DC-DC converter) 105, and then the power conversion unit (multi-output DC-DC converter) 105 converts the backup DC power BP come from the fast switching circuit 107 to generate the operation power OPP {OPP1-OPPN} required by the load 20.

On the other hand, it is assumed that the main DC power MP generated by the main DC power generating unit 101 is normally supplied, the control unit 109 generates the control signals CS 1 and CS2 to simultaneously turn off the switch transistors Q1 and Q2 and turn on the switch transistor Q3. In this way, the fast switching circuit 107 conducts the received main DC power MP to the power conversion unit (multi-output DC-DC converter) 105, and then the power conversion unit (multi-output DC-DC converter) 105 converts the main DC power MP come from the fast switching circuit 107 to generate the operation power OPP {OPP1-OPPN} required by the load 20.

Therefore, in the present exemplary embodiment, the main DC power MP and the backup DC power BP are switched by the fast switching circuit 107 composed of a plurality of switch transistors Q1-Q3 (i.e. the main DC power MP or the backup DC power BP is conducted to the post-end power conversion unit 105 (multi-output DC-DC converter)). Since a switching time (which is smaller than 4 ms) of each switch transistor (Q1-Q3) is substantially shorter than a switching time (which is greater than 50 ms) of the conventional relay, the backup DC power BP can be conducted to the input of the power conversion unit 105 (multi-output DC-DC converter) in a quite-short time even though the main DC power MP is abnormal (for example, disappeared or disabled). Accordingly, the output of the power conversion unit 105 (multi-output DC-DC converter) can still continuously and stably supply the operation power OPP required by the load 20.

In an actual application, the power supply apparatus 10 can be applied to the load 20 implemented as a computer system, or applied to the load 20 implemented as a communication system, though the invention is not limited thereto. When the power supply apparatus 10 is applied to the load 20 implemented as the computer system, the provided main DC power MP, the backup DC power BP and all of the operation DC voltages OPP (i=1-N) may all have a positive level. Moreover, when the power supply apparatus 10 is applied to the load 20 implemented as the communication system, the provided main DC power MP, the backup DC power BP and all of the operation DC voltages OPP (i=1-N) may all have a negative level.

However, regardless of the type of the load to which the power supply apparatus 10 is applied, the power supply apparatus 10 can conduct the backup DC power BP to the input of the power conversion unit 105 (multi-output DC-DC converter) within a quite-short time (for example, 4 ms, though the invention is not limited thereto) based on a fast switching characteristic (compared to the conventional relay) of the fast switching circuit 107 when the main DC power is abnormal (for example, disappeared or disabled). In this way, the output of the power conversion unit 105 (multi-output DC-DC converter) can continuously and stably supply the operation power OPP required by the load 20.

In summary, the power supply apparatus 10 of the invention has a power backup mechanism, in which the main DC power MP and the backup DC power BP are switched by the fast switching circuit 107 composed of a plurality of switch transistors Q1-Q3 (i.e. the main DC power MP or the backup DC power BP is conducted to the post-end power conversion unit 105 (multi-output DC-DC converter)). Since a switching time (which is smaller than 4 ms) of each switch transistor (Q1-Q3) is substantially shorter than a switching time (which is greater than 50 ms) of the conventional relay, the backup DC power BP can be conducted to the input of the power conversion unit 105 (multi-output DC-DC converter) in a quite-short time even though the main DC power MP is abnormal (for example, disappeared or disabled). Accordingly, the output of the power conversion unit 105 (multi-output DC-DC converter) can still continuously and stably supply the operation power OPP required by the load 20. In this way, the problems mentioned in the related art are effectively mitigated/resolved.

Besides, compared to the conventional relay, besides that the fast switching circuit 107 has the fast switching characteristic, it also has advantages of small volume (due to that the switch transistors Q1-Q3 can be fabricated as surface mounting devices (SMD)) and low switching loss. In overall, by using the fast switching circuit 107, not only the problems mentioned in the related art are effectively mitigated/resolved, a better implementation effect/technical effects are also achieved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power supply apparatus, comprising:
a main direct current (DC) power generating unit, configured to generate a main DC power;
a backup DC power generating unit, configured to generate a backup DC power;
a power conversion unit, configured to generate an operation power required by a load in response to one of the main DC power and the backup DC power; and
a fast switching circuit, coupled to the main DC power generating unit, the backup DC power generating unit and the power conversion unit, and comprising a plurality of switch transistors,
wherein the fast switching circuit is configured to receive the main DC power and the backup DC power, and conducts the backup DC power to the power conversion unit through a first portion of the switch transistors in response to a first control signal and a second control signal when the main DC power is abnormal, otherwise, conducts the main DC power to the power conversion unit through a second portion of the switch transistors in response to the first control signal and the second control signal when the main DC power is normally supplied.

2. The power supply apparatus as claimed in claim 1, wherein the first portion of the switch transistors comprises:
a first switch transistor, having a drain receiving the backup DC power, and a gate receiving the first control signal; and
a second switch transistor, having a source coupled to a source of the first switch transistor, a drain coupled to an input of the power conversion unit, and a gate receiving the first control signal.

3. The power supply apparatus as claimed in claim 2, wherein the second portion of the switch transistors comprises:
a third switch transistor, having a source receiving the main DC power, a drain coupled to the input of the power conversion unit, and a gate receiving the second control signal.

4. The power supply apparatus as claimed in claim 3, wherein each of the witch transistors is implemented by a power switch.

5. The power supply apparatus as claimed in claim 3, further comprising:
a control unit, coupled to the main DC power generating unit and the fast switching circuit, and configured to receive and detect whether the main DC power is abnormal, and accordingly generate the first control signal and the second control signal to switch the switch transistors, wherein the first control signal and the second control signal are inversed to each other.

6. The power supply apparatus as claimed in claim 5, wherein
the first and second switch transistors are turned on in response to the first control signal when the main DC power is abnormal, and are turned off when the main DC power is normally supplied; and
the third switch transistor is turned on in response to the second control signal when the main DC power is normally supplied, and is turned off when the main DC power is abnormal.

7. The power supply apparatus as claimed in claim 1, wherein the power conversion unit comprises a multi-output DC-DC converter, and the operation power comprises a plurality of operation DC voltages.

8. The power supply apparatus as claimed in claim 7, wherein the load comprises a computer system.

9. The power supply apparatus as claimed in claim 8, wherein the main DC power, the backup DC power and the operation DC voltages all have a positive level.

10. The power supply apparatus as claimed in claim 7, wherein the load comprises a communication system.

11. The power supply apparatus as claimed in claim 10, wherein the main DC power, the backup DC power and the operation DC voltages all have a negative level.

12. A power supply apparatus, comprising:
a power conversion unit, generating an operation power required by a load in response to one of a main DC power and a backup DC power; and
a fast switching circuit, coupled to the power conversion unit, and comprising a plurality of switch transistors,
wherein the fast switching circuit is configured to receive the main DC power and the backup DC power, and conducts the backup DC power to the power conversion unit through a first portion of the switch transistors in response to a first control signal and a second control signal when the main DC power is abnormal, otherwise, conducts the main DC power to the power conversion unit through a second portion of the switch transistors in response to the first control signal and the second control signal when the main DC power is normally supplied.

13. The power supply apparatus as claimed in claim 12, wherein the first portion of the switch transistors comprises:
a first switch transistor, having a drain receiving the backup DC power, and a gate receiving the first control signal; and
a second switch transistor, having a source coupled to a source of the first switch transistor, a drain coupled to an input of the power conversion unit, and a gate receiving the first control signal.

14. The power supply apparatus as claimed in claim 13, wherein the second portion of the switch transistors comprises:
a third switch transistor, having a source receiving the main DC power, a drain coupled to the input of the power conversion unit, and a gate receiving the second control signal.

15. The power supply apparatus as claimed in claim 14, wherein each of the witch transistors is implemented by a power switch.

16. The power supply apparatus as claimed in claim 14, further comprising:
a main DC power generating unit, coupled to the fast switching circuit, and configured to generate the main DC power; and
a backup DC power generating unit, coupled to the fast switching circuit, and configured to generate the backup DC power.

17. The power supply apparatus as claimed in claim 16, further comprising:
a control unit, coupled to the main DC power generating unit and the fast switching circuit, and configured to receive and detect whether the main DC power is abnormal, and accordingly generate the first control signal and the second control signal to switch the switch transistors, wherein the first control signal and the second control signal are inversed to each other.

18. The power supply apparatus as claimed in claim 17, wherein
the first and second switch transistors are turned on in response to the first control signal when the main DC power is abnormal, and are turned off when the main DC power is normally supplied; and
the third switch transistor is turned on in response to the second control signal when the main DC power is normally supplied, and is turned off when the main DC power is abnormal.

19. The power supply apparatus as claimed in claim 12, wherein the power conversion unit comprises a multi-output DC-DC converter, and the operation power comprises a plurality of operation DC voltages.

20. The power supply apparatus as claimed in claim 19, wherein the load comprises a computer system.

21. The power supply apparatus as claimed in claim 20, wherein the main DC power, the backup DC power and the operation DC voltages all have a positive level.

22. The power supply apparatus as claimed in claim 19, wherein the load comprises a communication system.

23. The power supply apparatus as claimed in claim 22, wherein the main DC power, the backup DC power and the operation DC voltages all have a negative level.
